(19) United States
(12) Patent Application Publication
(10) Pub. No.: US 2005/0027853 A1
(43) Pub. Date: Feb. 3, 2005

(54) System and method for collecting data regarding network service operation

(76) Inventors: Terry M. Martin, Fort Collins, CO (US); Jay D. Knitter, Wellington, CO (US); Blaine R. Southam, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/628,166

(22) Filed: Jul. 28, 2003

(51) Int. Cl. G06F 15/173

(52) U.S. Cl. 709/224; 709/217

(57) ABSTRACT

Disclosed are systems and methods for collecting data regarding network service operation. In one embodiment, a system and a method pertain to intercepting a message sent by a client and directed to a network service, storing information about the message, and transmitting the message to a destination network service. In another embodiment, a system and a method pertain to receiving a request from a client, intercepting a message sent by a network service and directed to the client, storing information about the message, and transmitting the message to the client.

### BACKGROUND

Network services, such as “web” services, are network-based applications that operate in a distributed computing environment to perform specific tasks in response to client requests. Currently, most such web services are focused on providing a variety of real world services, or information about such services, across the Internet.

To cite an example, a given web service may be designed to identify the cheapest long distance rates for a given client. In such a case, the client may provide various information to the web service such as a client identity, a city and state of residence, an indication of typical calling patterns, etc., and the web service will use that information to identify a service provider and/or calling plan that would cost the least for the client based upon the client-provided information. In making the determination as to which service provider and/or calling plan is best for the client, the web service may leverage the resources of one or more other web services, for instance hosted by one or more long distance service providers (e.g., AT&T™, Sprint™, MCI™, etc.). Specifically, the web service that was called upon by the client to return the best provider/plan may act in the capacity of a client relative to other web services in order to collect information from those services that is needed to make the provider/plan determination.

To ensure that a developed network service, as well as the network services it interacts with, is operating correctly it is desirable to collect data regarding communications that occur between network services. For instance, collecting information regarding the time at which a request was sent from the developed network service to another network service, as well as information as to the substance of the request, may be useful for purposes of profiling system operation, debugging service delivery problems, and identifying transmission and/or processing bottlenecks.

Currently, such information is collected by modifying the code of one or more of the network services to record this information. For instance, custom logging code may be integrated into a network service for the purpose of logging the information. Such insertion is highly invasive and normally requires substantial investment in terms of time and money for the development of the logging code and its integration into the network service. Moreover, even when a developer is willing to make such an investment, the developer may not have access to the network service code in the first place.

### SUMMARY

Disclosed are systems and methods for collecting data regarding network service operation. In one embodiment, a system and a method pertain to intercepting a message sent by a client and directed to a network service, storing information about the message, and transmitting the message to a destination network service.

In another embodiment, a system and a method pertain to receiving a request from a client, intercepting a message sent by a network service and directed to the client, storing information about the message, and transmitting the message to the client.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system in which data regarding network service operation may be collected.

FIG. 2 is a block diagram of an embodiment of a computing device on which a network service and message handler of the system of FIG. 1 can execute.

FIG. 3 is a flow diagram that illustrates an embodiment of system operation and data collection activities.

FIG. 4 is a schematic view that illustrates an embodiment of message exchange between components of the system of FIG. 1.

FIG. 5 is a schematic view of an embodiment of a session timing profile reflective of messaging activity shown in FIG. 4.

FIG. 6 is a flow diagram that illustrates an embodiment of operation of a message handler of a network service identified in FIGS. 1 and 4.

FIG. 7 is a flow diagram that summarizes an embodiment of operation of a message handler.

FIG. 8 is a flow diagram that summarizes a further embodiment of operation of a message handler.

### DETAILED DESCRIPTION

As described above, it is desirable to collect data regarding communications that occur between network services to evaluate how a developed network service, as well as the network services it interacts with, is operating. However, it is further desirable to collect such information in a non-invasive manner that does not require modification of the network service code and/or re-deployment of the network service.

As is discussed in the following, information as to network service operation can be collected by storing information about the messages that are sent from and received by a network service using one or more message handlers. In addition, network communications can be instrumented by the message handlers to facilitate the data collection process. With such information, system operation can be profiled and, if desired, the system can be reconfigured to improve performance and/or overcome problems (e.g., bugs, bottlenecks). Notably, the information may be collected in a testing environment to evaluate a network service prior to deployment, or may be used after deployment of the network service to ensure that the service is operating properly.

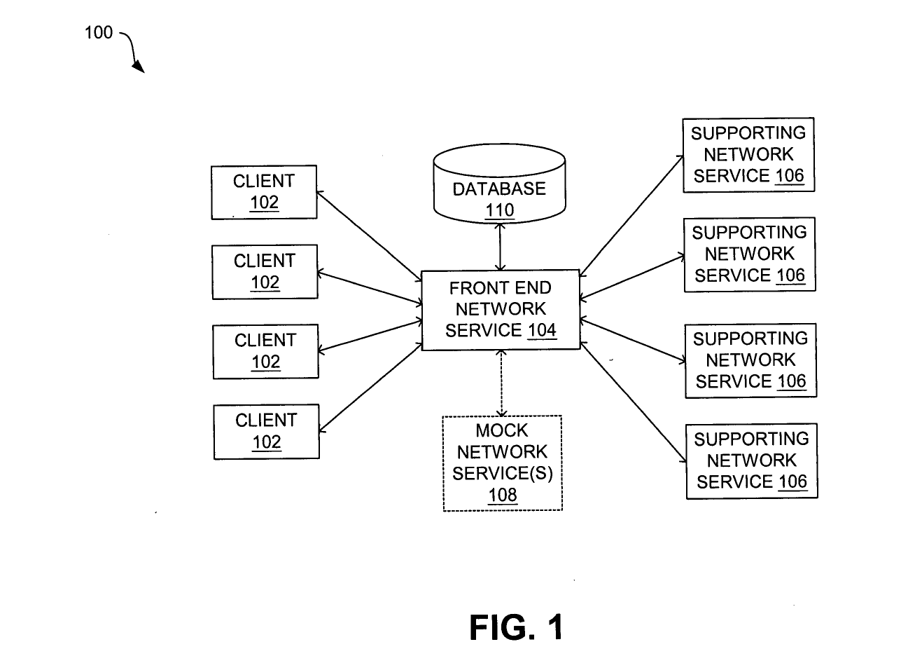

Referring now in more detail to the drawings, in which like numerals indicate corresponding parts throughout the several views, FIG. 1 illustrates an example system 100 in which network services may operate and information regarding this operation may be collected. As indicated in this figure, the system 100 generally comprises one or more clients 102, a front end network service 104, and one or more supporting network services 106 that are accessible to the front end network service via, for example, an external network (not shown), such as the Internet.

The one or more clients 102 are configured to make requests of the front end network service 104. In situations in which the front end network service 104 is being tested (e.g., prior to deployment), the one or more clients 102 may comprise at least one mock client that is configured to emulate the operation of an actual requesting client. Regardless, the clients 102 may comprise a network browser, such as a web browser that is configured to communicate on the World Wide Web (i.e. the “Web”) via hypertext transfer protocol (HTTP) and hypertext markup language (HTML), and/or an application comprising one or more user interfaces (UIs) that are used to collect information that is to be provided to the front end network service 104.

The front end network service 104 is a network service that, presumably, is the focus of the testing and/or system evaluation for which information is to be collected. The front end network service 104 may comprise a service that was developed and configured for utilization on the Web and, therefore, may comprise a “web” service. Regardless, the network service 104 is configured to both receive and supply content (i.e. static and/or dynamic content) over a network, such as the Internet. The network service 104 is typically configured to use standard Web protocols such as HTTP, HTML, extensible markup language (XML), and simple object access protocol (SOAP). As is known in the art, SOAP is a remote procedure call (RPC) and document exchange protocol used to request and reply to messages between web services. By way of example, the requests sent by the network service 104 comprise XML messages that are wrapped in SOAP envelopes and transmitted via HTTP.

The core functionality provided by the front end network service 104 depends upon the particular implementation. In most embodiments, however, the network service 104 is configured to communicate with other network services to satisfy requests made by the clients 102. By way of example, the front end network service 104 may comprise a service that identifies the least expensive telephone calling plan for the client, locates airline tickets that satisfy client-provided criteria (e.g., departure time, arrival time, cost, etc.), determines the most appropriate form of shipping based upon client requirements (e.g., airmail, next day delivery, etc.), identifies hotels that can accommodate a client itinerary, or the like.

The front end network service 104 may be configured (i.e. hard-coded) to interact with one or more of the supporting network services 106. For the purposes of this disclosure, the term “supporting network service” identifies a network (e.g., web) service that has been deployed for, normally public, use on a given network, such as the Internet. By way of example, the supporting network services 106 comprise web services that are hosted by third parties, such as those parties that provide services that the client is seeking (e.g., telephone services, plane ticket reservations, shipping services, hotel accommodations, etc.). Such supporting network services 106 may be contrasted with mock network services 108 that, in the testing scenario, may be provided to emulate the functionality of the supporting network services and which are controlled by those conducting the network service testing.

In a testing situation, unintended interaction between the front end network service 104 and the supporting network services 106 may be avoided using the mock network services 108. For instance, a message handler of the front end network service 104 may be configured to redirect certain communications (i.e. requests) sent from the front end network service and directed to one or more of the supporting network services 106. In such a case, the message handler may comprise, or may be configured to access, a redirection table (or other data structure) that maps network addresses (e.g., universal resource locators (URLs)) of various supporting network services 106 to network addresses (e.g., URLs) of mock network services 108 that emulate the operation of those supporting network services. Examples of a message handler operating in this redirection capacity are described in U.S. patent application Ser. No. ______ entitled “Systems and Methods for Testing Network Services” and having attorney docket number 200208274-1, filed Jul. 8, 2003, which is hereby incorporated by reference in its entirety into this disclosure.

When provided, the mock network services 108 comprise generic, data-driven code. Therefore, the mock network services 108 do not actually comprise the business logic of the supporting network services 106 that they emulate, and do not actually process requests as do the supporting network services. Instead, the mock network services 108 merely receive inputs, in the form of requests, and transmit outputs, in the form of responses to the requests. The mock network services 108 include, or may access, a response table (other data structure) that defines the operation of the service. The table of each service 108 maps a number of predefined requests to a corresponding number of pre-configured responses such that, when a mock network service 108 receives a request from the front end network service 104 (due to redirection by a message handler), the received request is compared to information stored within the table or other data structure, and that information is mapped to one of several pre-configured responses. The corresponding response may then be transmitted to the front end network service 104 and, like the requests, may comprise an XML message that is wrapped in a SOAP envelope and transmitted via HTTP.

As is further illustrated in FIG. 1, the system 100 includes a database 110, which is accessible to a message handler of the front end network service 104 (or which forms part of the message handler). As is described in greater detail below, the message handler is configured to store in the database 110 information regarding communications that are sent from and sent to the front end network service 104.

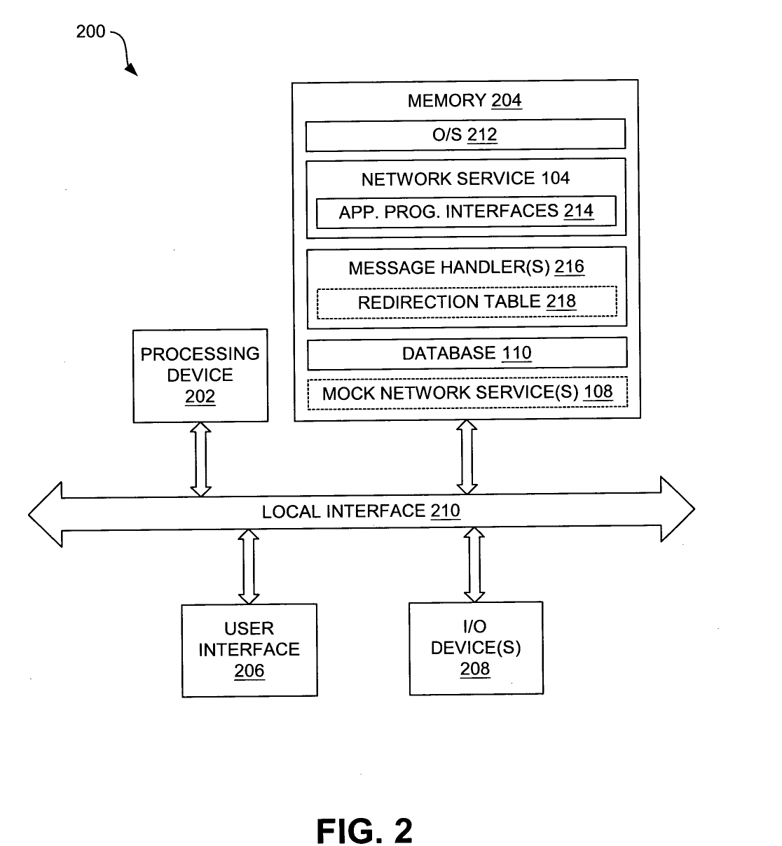

FIG. 2 is a schematic view of an example architecture for a computing device 200 on which the network service 104, as well as other components of the system 100, can execute. As indicated in FIG. 2, the computing device 200 comprises a processing device 202, memory 204, a user interface 206, and one or more input/output (I/O) devices 208, each of which is connected to a local interface 210.

The processing device 202 can include a general-purpose processor, a microprocessor, one or more application-specific integrated circuits (ASICs), a plurality of suitably configured digital logic gates, or other electrical configurations comprised of discrete elements that coordinate the overall operation of the computing device 200.

The memory 204 includes any one of a combination of volatile memory elements (e.g., random access memory (RAM)) and nonvolatile memory elements (e.g., hard disk, read only memory (ROM), Flash memory, etc.).

The user interface 206 comprises the components with which a user can interact with the computing device 200. For example, where the computing device 200 comprises a personal computer (PC) or similar computer, these components can comprise, for instance, a keyboard, mouse, and a display.

With further reference to FIG. 2, the one or more I/O devices 208 comprise components that are adapted to facilitate connection of the computing device 200 to another device and may therefore include one or more serial, parallel, small computer system interface (SCSI), universal serial bus (USB), IEEE 1394 (e.g., Firewire™), or other communication components. In addition, the I/O devices 208 comprise the various components used to transmit and/or receive data over a network. By way of example, such components include one or more of a modulator/demodulator (e.g., modem), wireless (e.g., RF) transceiver, and/or a network card.

The memory 204 comprises various programs, in software and/or firmware, including an operating system (O/S) 212 and the network service 104. The O/S 212 controls the execution of other software and provides scheduling, input-output control, file and data management, memory management, and communication control and related services. Optionally, the O/S 212 may incorporate or support a virtual machine, such as a JVM, on which the network service 104 executes.

The network service 104 includes one or more application program interfaces (APIs) 214 that are configured to call at least one message handler 216, which may include a redirection table 218 that is used to redirect requests to a mock network service 108. Each message handler 216 comprises a mechanism that is configured to intercept and process messages independent of the underlying network service code. In cases in which the messages sent and received by the network service 104 are SOAP messages (e.g., XML messages wrapped in SOAP envelopes), the message handlers 216 comprise SOAP message handlers. The message handlers 216 can be implemented by, for instance, modifying APIs 214 of the network service code to call a message handler each time a message is about to be sent or has been received. Such modification of the APIs 214 can be made at hook points or ports of the APIs, which are typically integrated into such APIs, particularly in the case of SOAP APIs. Accordingly, instead of rewriting the existing network service code to collect data, the APIs 214 of the code are merely leveraged to implement the message handlers 216 to thereby enable non-invasive data collection. Notably, the underlying network service code need not “know” that this data collection is occurring, and the network service developer need not know anything about the message handler 216, except how to install and configure it.

Although a single message handler 216 may be implemented to intercept all messages, two or more such handlers can be used, for instance one handler being configured to intercept outgoing messages and another handler being configured to intercept incoming messages. As is described in greater detail below, the message handlers 216 are configured to store data regarding the messaging activity of its associated network service (network service 104 in this case), and further can be used to instrument the messages for purposes of sharing such data and/or obtaining further such data. The configuration of the message handlers 216 is particular to the underlying implementation in which it is used. More specifically, the message handlers 216 are written for the platform on which they execute so as to be platform-specific. By way of example, the message handlers 216 can be Java-specific message handlers that are configured for use on a Java platform with a specific SOAP messaging API.

As is further indicated in FIG. 2, the memory 204 may further comprise the database 110 and the one or more mock network services 108 identified in FIG. 1. Although those components are shown as executing on the computing device 200, one or more of those components can execute on one or more other computing devices (e.g., PC or server), if desired.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can be used by or in connection with an instruction execution system, apparatus, or device, such as a computer-based system, processor-containing system, or other system that can fetch the instructions from the instruction execution system, apparatus, or device and execute the instructions.

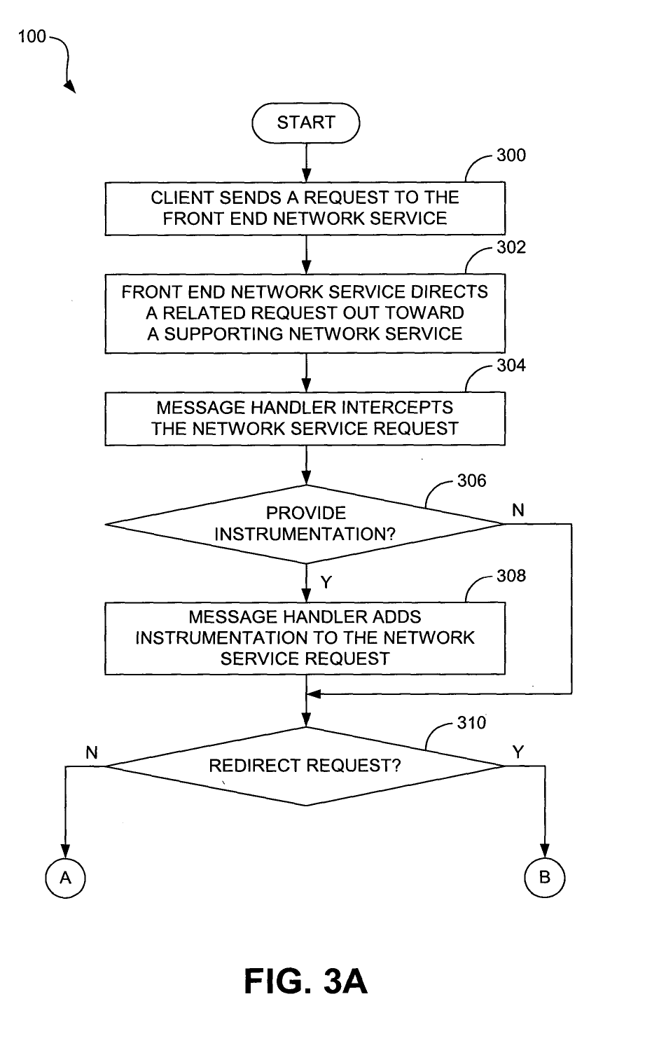

Example systems having been described above, examples of system operation will now be discussed in relation to FIGS. 3A and 3B. It is noted that process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

With reference to block 300 of FIG. 3A, a client 102 first sends a request to the front end network service 104. After the request is received, the front end network service 104 directs a related request to a supporting network service 106, as indicated in block 302. Because of the presence of the message handler(s) 216, the request is intercepted, as indicated in block 304. Once having intercepted the request, a message handler 216 can perform various actions both related to request redirection and data collection.

Referring next to decision block 306, a message handler 216 determines whether to provide instrumentation to the intercepted request before it is delivered to a further network service. As is described in greater detail below, such instrumentation can, for example, comprise information regarding the substance of the request as well as information as to when the request was (ultimately) transmitted by the message handler 216 to the other network service. If no such instrumentation is to be provided, flow continues to decision block 310 described below. If, on the other hand, the request is to be instrumented, flow continues on to block 308 at which the implicated message handler 216 adds instrumentation information to the network service request.

With reference to decision block 310, the message handler 216 next determines whether to redirect the request to a mock network service 108. For instance, in the testing scenario, it may be desirable to redirect communications intended for supporting network services 106 to the mock network service(s) 108, which emulate(s) the supporting network services to, for example, avoid incurring charges associated with actually interacting with the supporting network services. If no such redirection is to be performed (e.g., the front end network service 104 is not merely being tested), flow continues to block 312 of FIG. 3B at which the message handler 216 forwards the request to the supporting network service 106 for which the related request was intended. However, if redirection is warranted (e.g., in the testing/development scenario), flow continues to block 314 of FIG. 3B at which the message handler 216 redirects the request to a mock network service 108 that will emulate the operation of the intended supporting network service 106.

When the related request is forwarded (block 312) or redirected (block 314), the implicated message handler 216 stores data regarding the service request, as indicated in block 316. The nature of the data that is stored may vary with the system implementation. By way of example, however, the message handler 216 at least stores data regarding the substance of the request and information as to when the request was transmitted to the destination network service. Therefore, the data stored in block 316 may comprise the same data or data similar to that which was added by instrumenting the request (block 308 of FIG. 3A).

After the related request has been received by the destination network service (a supporting network service 106 and/or a mock network service 108), that network service determines what response to provide and, once that response is transmitted, the front end network service 104 receives the response, as indicated in block 318. Notably, the response can first be routed through a message handler 216 (not indicated) so that the message handler may perform other data collection activities, as described below. Once the response is received by the front end network service 104, the front end network service determines what response to then provide to the client 102, as indicated in block 320, and, as indicated in block 322, sends an appropriate response to the client to complete the flow for the request session.

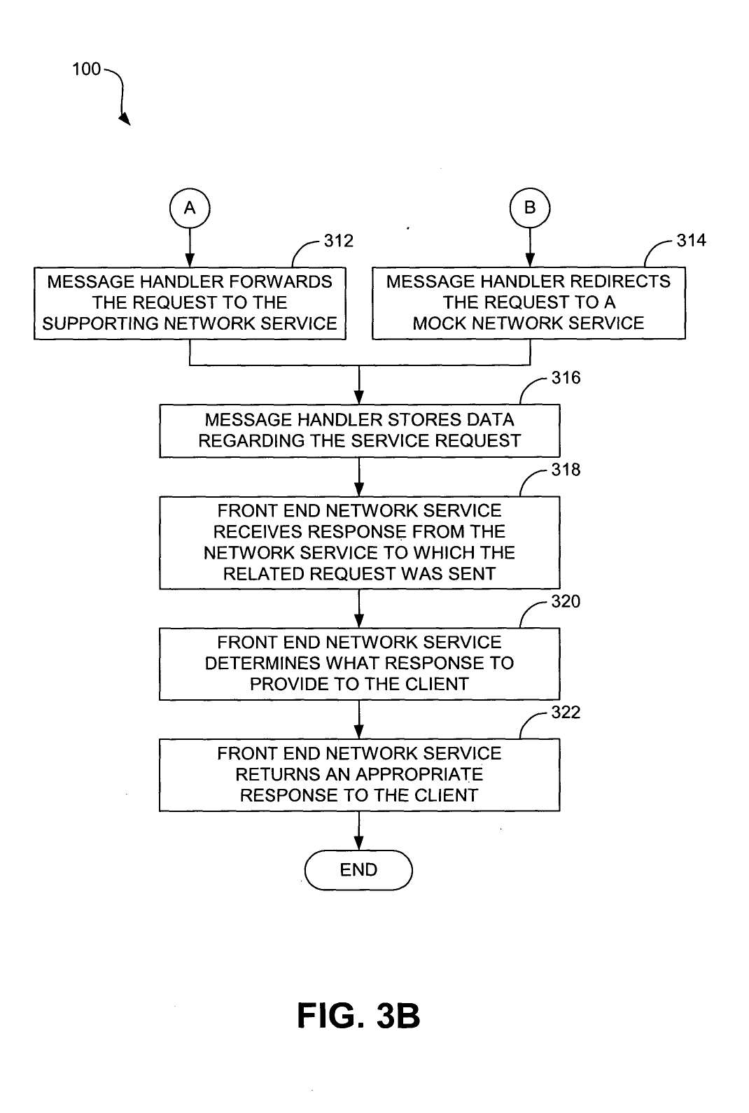

Although useful information can be obtained by only collecting information with a handler at one location (e.g., at the front end network service 104), more information about system operation can be collected when each component involved in a given request session is equipped with one or more message handlers that collect data and/or instrument messages that are transmitted. In such a case, information can be obtained that provides insight as to the interaction of those components for the entire request session or “round trip.” FIG. 4 is a schematic view that illustrates an example of a message exchange 400 between a client 102, the front end network service 104, and a supporting network service 106. As indicated in this figure, each of those components comprises a message handler, H, that intercepts either outgoing or incoming messages.

In the example of FIG. 4, the client 102 comprises a message handler that intercepts outgoing messages (requests) to the front end network service 104, and a further message handler that intercepts incoming messages (responses) received from the front end network service. The front end network service 104 includes a message handler that intercepts incoming messages (requests) from the client 102, a message handler that intercepts outgoing messages (requests) to the supporting network service 106, a message handler that intercepts incoming messages (responses) from the supporting network service, and a message handler that intercepts outgoing messages (responses) to the client. Finally, the supporting network service 106 comprises a message handler that intercepts incoming messages (requests) from the front end network service 104, and a message handler that intercepts outgoing messages (responses) to the front end network service.

With the above-described configuration, a request (1) can be sent from the client 102 to the front end network service 104, which can then process the request. Once having processed the request, the front end network service 104 can send a related request (2) to the supporting network service 106 in an effort to cull the information needed to respond to the client's request. The supporting network service 106 can then process its received request and return an appropriate response (3) to the front end network service 104. The front end network service 104 can then determine what information to provide the client 102 and then send a response (4) to the client.

Because of the implementation of the message handlers, various information about the request session can be collected and/or shared. By way of example, the information that is collected and/or instrumented into each message can include a source name of the sender of a message, a message type (e.g., request or response), a destination name of the intended recipient, a request sent time (i.e. a timestamp indicating when the message was sent), and a response received time (i.e. a timestamp indicating when the message was received). Moreover, in a configuration in which a message handler is present at each message start and end point, further information may be collected including, for example, a session identification that identifies that the message is part of a particular request session (e.g., a response sent from the supporting network service 106 to the front end network service 104, the response being related to an initial request sent by the client 102 to the front end network service), a request received time (i.e. a timestamp indicating when a request to which a response is responsive was received), and a response sent time (i.e. a timestamp indicating when a response was sent by the sender). It is noted that the latter information may need to be propagated within a given system component to be made available for collection. For example, if the supporting network service 106 is to instrument a response to the front end network service 104 with the session identification or the request received time, the supporting network service may obtain that information from a received request and add the information to the outgoing response to that request.

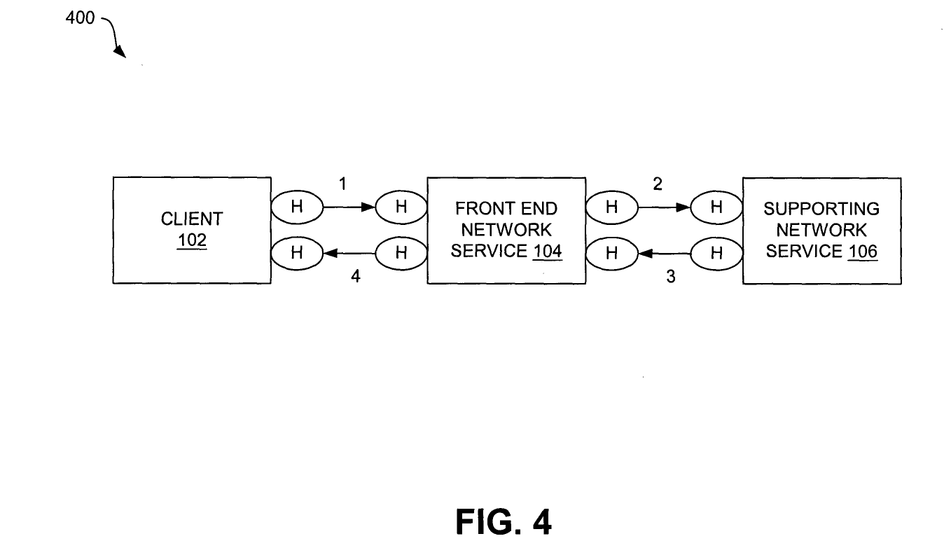

By collecting the above information, a session timing profile can be generated that contains trace information for all messages pertinent to a given request session initiated by the client 102. An example of such a session timing profile 500 is illustrated in FIG. 5. In this example, various messages have been communicated between a client 102 (“client A”), a front end network service 104 (“service A”), and a supporting network service 106 (“service B”). As is apparent from FIG. 5, a user, for instance an administrator, can, with reference to the profile 500, identify the sequence of messages sent and received for each session and, therefore the time that was required to transmit each message, as well as the processing time spent by each system component in responding to a received message. From this information, a clear picture of system behavior, network latency and network service processing time may be gleaned.

In addition to the session trace information, qualitative information regarding a request session can be collected. For instance, the substance of a transmitted request or a received response can be collected by the message handlers and stored in a local database (e.g., in database 110). By way of example, a portion of or the entirety of the message (e.g., the XML message) can be stored. From this information, system operation can be analyzed to determine if correct responses are being received in response to given requests. Furthermore, it can be determined whether certain actions are taking relatively longer to process as compared to other actions, potentially identifying a software glitch or inefficiency. Moreover, the behavior of the system as a whole can be observed to help debug system components. For example, if it is observed from the session trace that a message sent from the client 102 to the front end network service 104 was actually delivered directly to the supporting network service 106, the front end network service may have a glitch or bug that may require fixing.

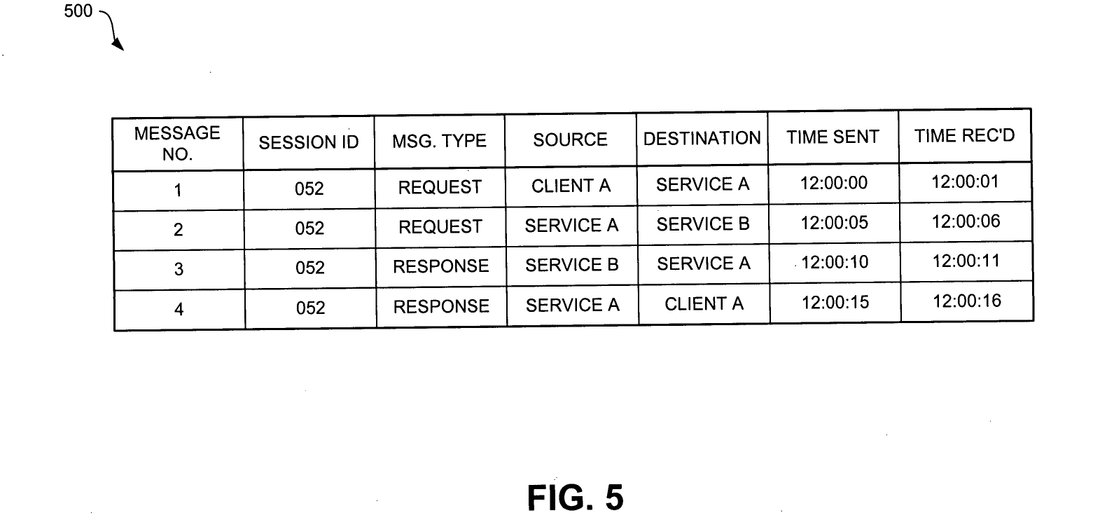

FIG. 6 provides an example of operation of a message handler 216 of the front end network service 104 in facilitating data collection in the example session illustrated in FIG. 4. More specifically, FIG. 6 describes operation of a message handler 216 in intercepting a request to be sent from the front end network service 104 to the supporting network service 106 (i.e. message “2” in FIG. 4), and intercepting a response received from the supporting network service and intended for receipt by the front end network service (i.e. message “3” in FIG. 4). Accordingly, in the example of FIG. 6, a single message handler 216 is presumed to be configured to intercept both outgoing and incoming messages. As noted above, however, two independent handlers, one being configured to intercept outgoing messages and the other being configured to intercept incoming messages, could be used instead. Notably, although the discussion in FIG. 6 is focused on activities of a front end network service message handler 216, the discussion is more generally indicative of the operation of a message handler of any system component (e.g., the client 102 and/or supporting network service 106).

Beginning with block 600 of FIG. 6, the message handler 216 first intercepts a request generated by the front end network service 104 and intended for a supporting network service 106. By way of example, the request comprises an XML message wrapped in a SOAP envelope. Once the request is intercepted, the message handler 216 identifies any session information that is to be used to instrument the intercepted message and/or that is to be stored by the handler, as indicated in block 602. This information may comprise, for example, the session to which the request pertains, the type of message that is being sent, etc. Next, the message handler 216 interjects instrumentation information into the request, as indicated in block 604. In cases in which the request comprises a SOAP message (e.g., an XML message wrapped in a SOAP envelope), the instrumentation information may be inserted in a header of the message by a SOAP message handler. As noted above, this information can comprise, for example, a session identification, a source name of the sender of the message (i.e. of the front end network service 104), a message type, a destination name of the intended recipient (i.e. of the supporting network service 106), and a request sent time (i.e. a timestamp identifying when the message was, ultimately, sent).

Once the message has been instrumented, the message handler 216 transmits the request to the supporting network service 106, as indicated in block 606. Simultaneous to that transmission or thereafter, the message handler 216 stores data regarding the service request in the database 110, as indicated in block 608. This data can be similar to or the same as the information that was interjected into the request as described above. Therefore, what is stored may be a session identification, a source name of the sender of the message, a message type, a destination name of the intended recipient, and a request sent time. In addition, so as to maintain a log of the particular details of the request that was transmitted, a portion of or the entirety of the request (e.g., the XML message) may be stored.

After the request has been transmitted to and received by the supporting network service 106, the supporting network service determines the appropriate response. Thereafter, the supporting network service 106 may transmit a response back to the front end network service 104. It is assumed for purposes of this discussion that, as indicated in FIG. 4, the supporting network service 106 includes a message handler that is configured to intercept the request received from the front end network service 104, and also intercept the transmitted response and instrument it with information similar to that interjected by the message handler 216 in block 604. This information may comprise, for example, the session identification, a request received time (i.e. a timestamp indicating when the requests sent by the front end network service 104 was received by the supporting network service 106), and a response sent time (i.e. a timestamp indicating when the response was sent by the supporting network service).

With reference next to block 610 of FIG. 6, the message handler 216 of the front end network service 104 intercepts the response sent from the supporting network service 106. At this point, the message handler 216 identifies any information interjected into the response by the message handler of the supporting network service 106, as indicated in block 612. Once that information has been identified, the message handler 216 stores data regarding the response in the database 110, as indicated in block 612. This information includes, for example, the session identification, the source name of the sender of the message (i.e. of the supporting network service 106), a message type, a destination name of the intended recipient (i.e. of the front end network service 104), a request received time (i.e. a timestamp indicating when the supporting network service received the request), and a response sent time (i.e. a timestamp indicating when the response was sent by the supporting network service). In addition to identifying any interjected information, the message handler 216 further identifies other information regarding the response that is to be stored, as indicated in block 614. This information includes, for instance, a response received time (i.e. a timestamp indicating when the response was received by the message handler 216) as well as the substance of the response.

Once the interjected information and other information has been identified (blocks 612 and 614), the message handler 216 stores that data in the database 110, as indicated in block 616. For instance, this data is used to populate a session timing profile, such as that illustrated in FIG. 5, which is stored in the database 110.

As can be appreciated from the above discussion, the storage of data and/or the instrumentation of messages enables a user (e.g., service administrator) to obtain information regarding the messaging interactions between network services, as well as between clients and network services. Depending upon the nature of the data that is collected and/or instrumented, information as to network latency and network service processing time may be gleaned. Furthermore, such information may be obtained relative to the particular requests that are transmitted. For instance, it may be determined from the collected data that some requests (e.g., determining hotel availability) require a large amount of time to receive a response while other requests (e.g., determining flight availability) may require less. In such a case, investigations may be performed to determine whether that phenomenon is occurring due to a flaw in the system (e.g., in the front end network service 104 or the supporting network service 106). Additionally, because the substance of the requests and the responses is stored, the accuracy of system operation may be analyzed.

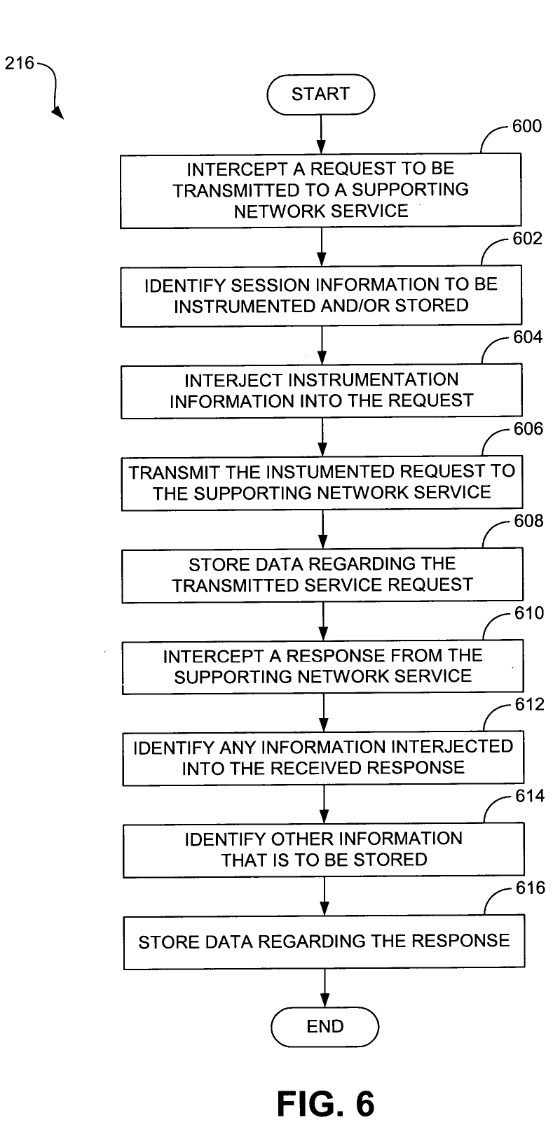

In view of the above disclosure, an embodiment of operation of a message handler 216 can be summarized as shown in FIG. 7. Beginning with block 700, the message handler 216 intercepts a message sent by a client and directed to a network service. The message handler 216 then stores information about the message, as indicated in block 702, and then transmits the message to a destination network service, as indicated in block 704.

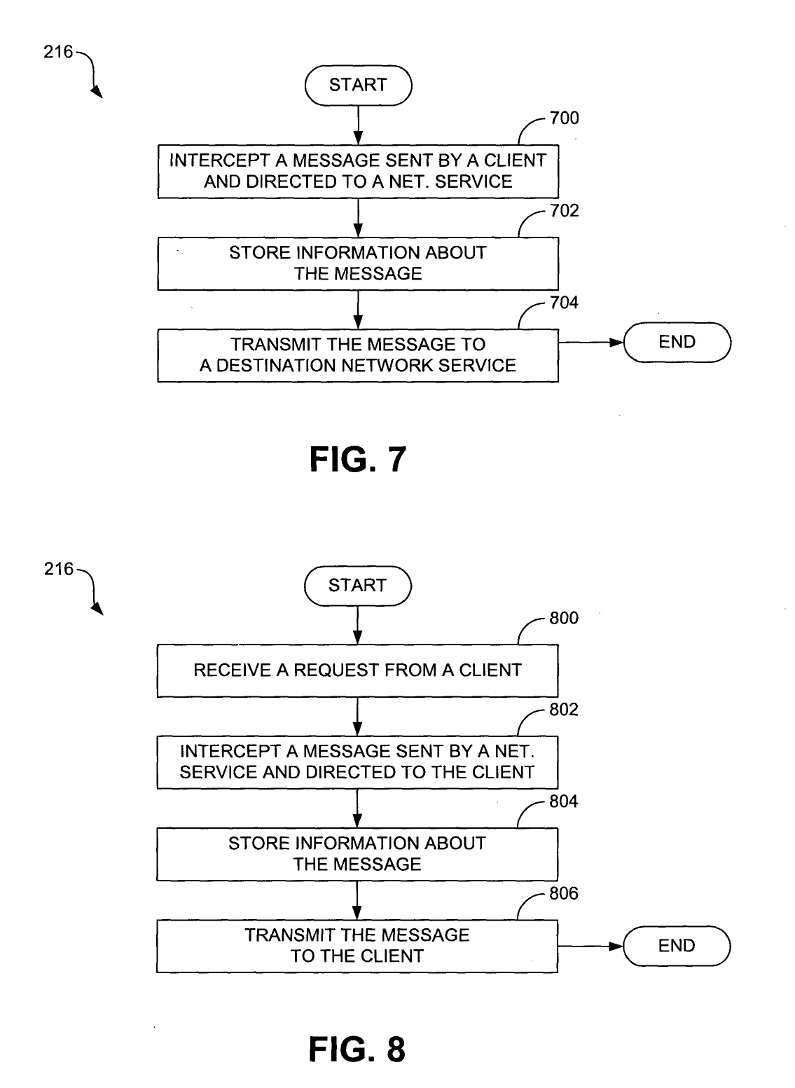

A further embodiment of operation of a message handler 216 is summarized by FIG. 8. Beginning with block 800, the message handler 216 receives a request from a client. A response may then be sent to that request. Accordingly, the message handler 216 can then intercept a message sent by a network service and directed to the client, as indicated in block 802. The message handler 216 can then store information about the message, as indicated in block 804, and then transmit the message to the client, as indicated in block 806.

1. A method for collecting data regarding network service operation, the method comprising:
intercepting a message sent by a client and directed to a network service;
storing information about the message; and
transmitting the message to a destination network service.

2. The method of claim 1, wherein intercepting a message sent by a client comprises intercepting a message sent by a network service acting in the capacity of a client.

3. The method of claim 1, wherein intercepting a message comprises intercepting a message using a message handler that is called by the client.

4. The method of claim 1, wherein storing information about the message comprises storing information about the message using the message handler that is called by the client.

5. The method of claim 4, wherein storing information about the message comprises storing information about at least one of a session identification, a source name of the sender of the message, a message type, a destination name of the intended recipient, a request sent time, and substance of the message.

6. The method of claim 1, further comprising interjecting instrumentation information into the message prior to transmitting the message to the destination network service.

7. The method of claim 6, wherein interjecting instrumentation information comprises interjecting instrumentation information using a message handler that is called by the client.

8. The method of claim 7, wherein interjecting instrumentation information comprises adding instrumentation information to a header of the message.

9. The method of claim 7, wherein interjecting instrumentation information comprises interjecting at least one of a session identification, a source name of the sender of the message, a message type, a destination name of the intended recipient, and a request sent time.

10. The method of claim 1, further comprising receiving a response from the destination network service and storing data regarding the response.

11. The method of claim 10, wherein storing data regarding the response comprises storing data using a message handler that is called by the client.

12. The method of claim 10, wherein storing data regarding the response comprises storing at least one of a session identification, a source name of the sender of the message, a message type, a destination name of the intended recipient, a request received time, a response sent time, and a response received time.

13. A method for collecting data regarding network service operation, the method comprising:
receiving a request from a client;
intercepting a message sent by a network service and directed to the client;
storing information about the message; and
transmitting the message to the client.

14. The method of claim 13, wherein intercepting a message comprises intercepting a message using a message handler that is called by the network service and wherein storing information about the message comprises storing information about the message using the message handler.

15. The method of claim 14, wherein storing information about the message comprises storing information about at least one of a session identification, a source name of the sender of the message, a message type, a destination name of the intended recipient, a request received time, a response sent time, and substance of the message.

16. The method of claim 13, further comprising interjecting instrumentation information into the message prior to transmitting the message to the client using a message handler that is called by the network service.

17. The method of claim 16, wherein interjecting instrumentation information comprises interjecting at least one of a session identification, a source name of the sender of the message, a message type, a destination name of the intended recipient, a request received time, a response sent time, and substance of the message.

18. A system for collecting data regarding network service operation, the system comprising:
means for intercepting a message sent by a client and directed to a network service;
means for storing information about the message;
means for interjecting instrumentation information into the message; and
means for transmitting the instrumented message to a destination network service.

19. The system of claim 18, wherein the means for intercepting a message, for storing information, for interjecting instrumentation, and for transmitting comprise a message handler that is called by the client.

20. The system of claim 19, wherein the message handler is configured to store at least one of a session identification, a source name of the sender of the message, a message type, a destination name of the intended recipient, a request sent time, and substance of the message.

21. The system of claim 19, wherein the message handler is configured to interject at least one of a session identification, a source name of the sender of the message, a message type, a destination name of the intended recipient, and a request sent time.

22. The system of claim 19, wherein the message handler is configured to receive a response from the destination network service and store data regarding the response.

23. The system of claim 22, wherein the message handler is configured to store, in relation to the received response, at least one of a session identification, a source name of the sender of the message, a message type, a destination name of the intended recipient, a request received time, a response sent time, and a response received time.

24. The system of claim 19, wherein the message handler is a simple object access protocol (SOAP) message handler.

25. A message handler stored on a computer-readable medium, the handler comprising:
logic configured to intercept messages sent by a client and directed to a network service;
logic configured to store information about the message; and
logic configured to transmit the message to a network service.

26. The message handler of claim 25, wherein the logic configured to store information about the message comprises logic configured to store information about at least one of a session identification, a source name of the sender of the message, a message type, a destination name of the intended recipient, a request sent time, and substance of the message.

27. The message handler of claim 25, further comprising logic configured to interject instrumentation information into the message.

28. The message handler of claim 27, wherein the logic configured to interject instrumentation information comprises logic configured to interject at least one of a session identification, a source name of the sender of the message, a message type, a destination name of the intended recipient, and a request sent time.

29. The message handler of claim 25, further comprising logic configured to receive a response from the destination network service and logic configured to store data regarding the response, the data regarding the response comprising at least one of a session identification, a source name of the sender of the message, a message type, a destination name of the intended recipient, a request received time, a response sent time, and a response received time.

30. The message handler of claim 25, wherein the handler is a simpleobject access protocol (SOAP) message handler.

31. A system, comprising:
a network service comprising an application program interface (API) that is configured to call a message handler; and
a message handler that is called by the API, the message handler being configured to intercept requests sent by the network service and directed to a supporting network service, to store information about the request, to interject information into the request, to transmit the message to the supporting network service, to receive a response from the supporting network service, and to store information about the response.

32. The system of claim 31, wherein the message handler is configured to, in regard to the request, store information about at least one of a session identification, a source name of the sender of the message, a message type, a destination name of the intended recipient, a request sent time, and substance of the message.

33. The system of claim 31, wherein the message handler is configured to, in regard to the response, store information about a session identification, a source name of the sender of the message, a message type, a destination name of the intended recipient, a request received time, a response sent time, and a response received time.

34. The system of claim 31, wherein the message handler is a simple object access protocol (SOAP) message handler.
